(19) United States
(12) Patent Application Publication
(10) Pub. No.: US 2005/0076764 A1
(43) Pub. Date: Apr. 14, 2005

(54) Acoustical stress member

(76) Inventor: Michael W. Davis, Midland, MI (US)

Correspondence Address: MCKELLAR IP LAW, PLLC, 784 SOUTH POSEYVILLE ROAD, MIDLAND, MI, 48640, US

(21) Appl. No.: 10/683,528

(22) Filed: Oct. 10, 2003

(51) Int. Cl. G10D 3/00

(52) U.S. Cl. 84/299

(57) ABSTRACT

A device that reduces the stress on the face or sound board of stringed instruments by independently supporting the terminus of the strings and being mounted internally of the instrument.

The invention claimed and disclosed herein deals with device that reduces the stress on the face or sound board of stringed instruments by independently supporting the terminus of the strings by an internally mounted device.

### BACKGROUND OF INVENTION

This invention deals with a device that has the ability to reduce stress on the soundboard or face of a stringed instrument by independently supporting the termination of the strings via the stress member. It is common in the art to use supports for the bridge of stringed instruments as disclosed in U.S. Pat. No. 3,892,159 issued to Houtsma, Jul. 1, 1975 or as disclosed in U.S. Pat. No. 5,686,677 issued to Herbert, Nov. 11, 1997. Both patents use supporting structures attached to the bottom of the inside top of the instrument for support. The present invention overcomes the need to support the bridge on the soundboard by independently supporting the terminus of the. strings beyond the bridge and independently of the sound board portion of the instrument. Houtsma supra, column 2, lines 19 through 37 discloses an example of the stress placed on stringed instruments according to the prior art. The strings, bridge and the soundboard of these instruments can undergo varied and immense strain.

In the present invention the stress member is anchored inside the body cavity of the stringed instrument thus eliminating any stress from the bridge or the soundboard, face of the instrument. The prior art clearly focuses on securing the bridge to the stringed instrument surface and disclose the independent freestanding support of the stress member anchoring the strings beyond the bridge, but on the surface of the soundboard. In the instant invention, the stress member is attached to the inside of the instrument removing essentially all the stress from the bridge and soundboard.

The problem of the bridge warping or becoming loose due to stress from supporting the strings of the instrument has thus been eliminated. There are other advantages to the removal of the stress from the soundboard or the face of the instrument, which is the improved quality of the tone that emanates from the modified instrument.

### THE INVENTION

The invention disclosed and claimed herein is a device to independently support the terminus of strings on a stringed instrument. The device comprises in combination: a vertical mount having a top portion, a bottom portion, two sides, a front surface, and a back surface. There is also an upper support arm having a near end, distal end, an upper surface, and an under surface, wherein the distal end of the upper support arm supports a vertical string support. The upper support arm near end terminates at the back surface of the vertical mount essentially at the top portion, the upper support arm being supported by a lower support arm that attaches to the vertical mount, at the back surface, at the bottom portion thereof.

The lower support arm extends under the upper support arm and attaches to the under surface of the upper support arm near its distal end, the vertical string support attaching to the distal end of the upper support arm such that the vertical string support extends above the upper support arm.

Another embodiment of this device is a unitary construction of the device. The independent support of the strings allows for a reduction in the frictional forces placed on the strings while delivering a more consistent tension upon the strings. Another aspect of the internally mounted stress member is it does not aesthetically change the character of the instrument. For those instruments that do not have strings attached directly to the bridge and, which are generally secured just beyond the bridge, they are still secured to the face of the instrument causing stress to develop on the soundboard or face of the instrument. For those instruments that have a tail piece, such as a cello, the strings are anchored to the tail piece and it is secured to the bottom of the instrument. There is still stress placed on the face of those instruments because the strings are drawn across the face and around the bottom end, thus not eliminating stress from the bridge and soundboard or face of the instrument. Here again the stress member of the instant invention differs from the prior art because essentially all stress from string termination and support are eliminated from the face of the instrument. The stress member also allows the stringed instrument manufacturer to adapt to the changes made through the implementation of the stress member. There is no longer a need for bracing the inside top of the instrument. This allows manufacturers to change the quality of sound and tone through manipulation of these areas that are now free from blocking and bracing.

### A BRIEF DESCRIPTION OF THE DRAWINGS

FIG. 1 is a full side view showing the interior of an acoustical guitar with the stress member mounted to the front wall, illustrating the stress member as a four piece unit.

FIG. 2 is a full side view showing the interior of a standard acoustical guitar with the stress member mounted to the front wall, illustrating the stress member as a unitary structure.

FIG. 3 is a full top view of a stringed instrument.

### DETAILED DESCRIPTION OF THE INVENTION

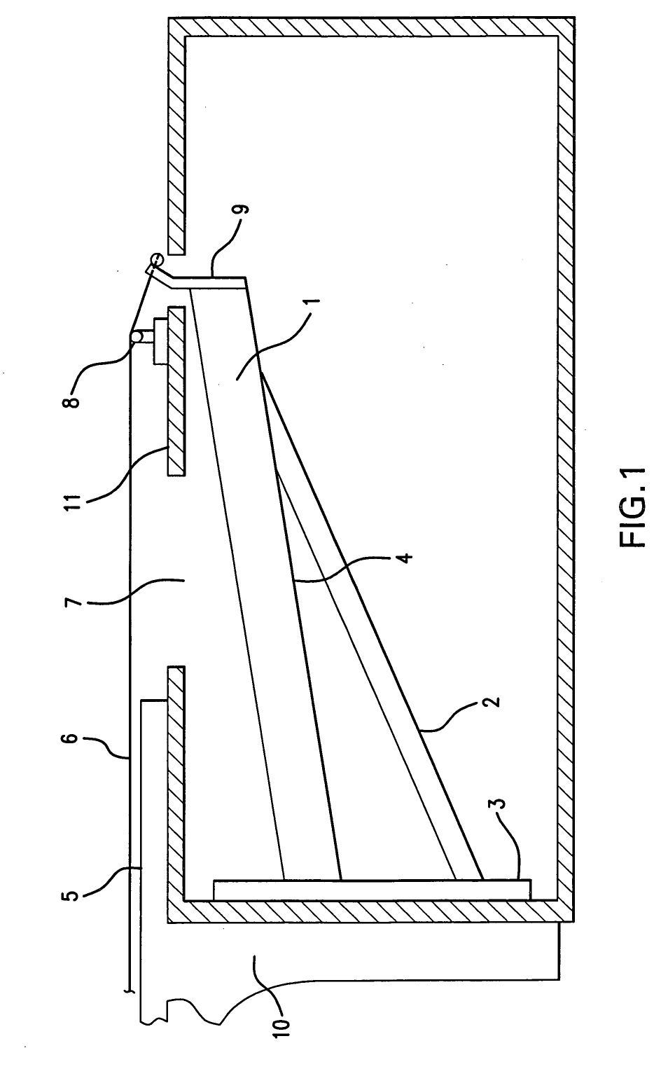

Turning now to FIG. 1 that is a full side view showing the interior of an acoustical guitar with the stress member 1 mounted to the front wall, illustrating the stress member as a four piece unit. The vertical mount 3 is secured to the front wall of the stringed instrument. The lower support arm 2 rises from the bottom of the vertical mount 3 and terminates near the upper support arm 4 terminus. At the terminus of the upper support arm is a vertical plate or string mount 9 to which the strings are secured. The fret board 5 passes over the heel 10 and terminates just short of the sound hole 7 with the strings 6 crossing over sound hole 7 and continuing over the center portion of the soundboard 11, but not mounted thereon. The strings 6 continue over the bridge 8 where they are secured into the string mount 9.

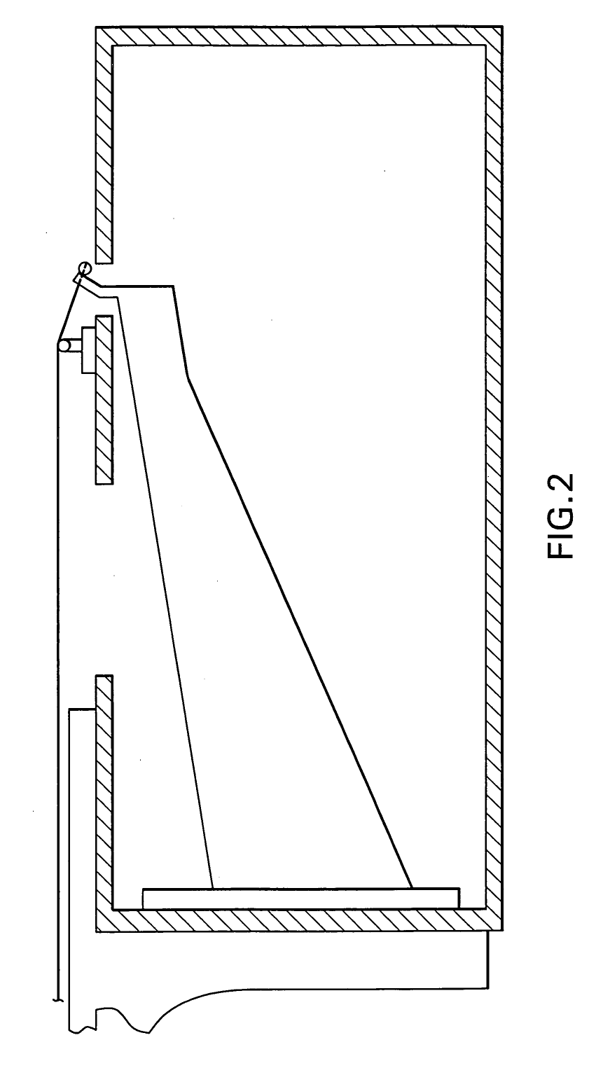

FIG. 2 is a side view showing the interior of a standard acoustical guitar with the stress member mounted to front wall of the sound box, illustrating the stress member as a unitary structure. The stress member is mounted to the front wall of the internal cavity of the stringed instrument. Illustration depicts stress member rising up to support top portion that terminates into the string mount securing the strings.

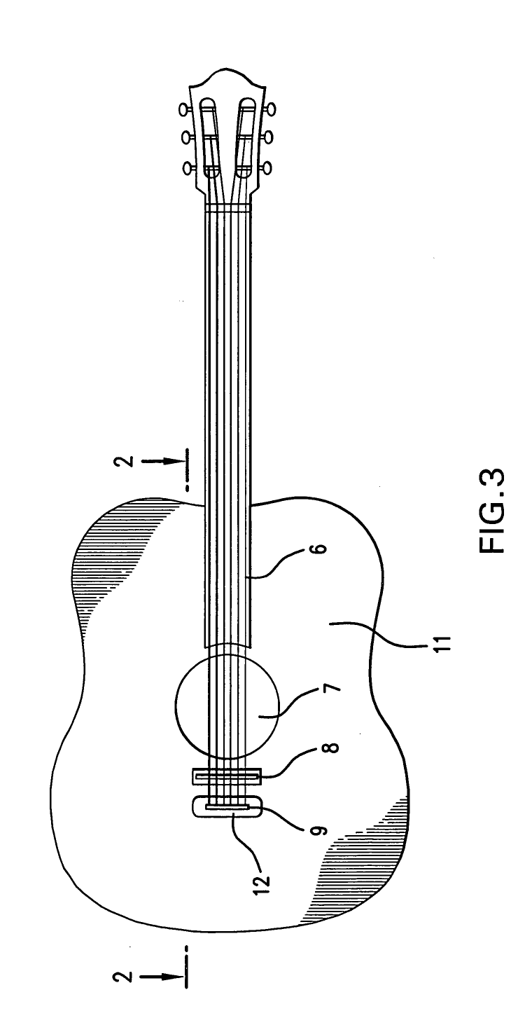

FIG. 3 is a full top view of an acoustical guitar showing the termination of the guitar strings 6 into the stress member 9. Also shown is the soundboard 11, the bridge 8 and the sound hole 7. The opening in the surface of instrument that receives the stress member is 12.

The vertical string support can also be made adjustable. The vertical string support is adjustable up and down. Also the vertical string support can be adjustable horizontally left to right and right to left. This allows for different angles to be created between the bridge and the string termination.

The location where the stress member is mounted internally is variable in that, it can be located anywhere within the body of the instrument and still be within the scope of the disclosed invention.

The materials that the stress member can be manufactured from includes but are not limited to, metals, plastics, wood, plastic composites, fiber glass, ceramics, glass, PVC's, graphite's or any combination of these and other materials.

1. A device comprising in combination:
a vertical mount having a top portion, a bottom portion, two sides, a front surface, a back surface;
an upper support arm having a near end, distal end, an upper surface, and an under surface, wherein the distal end of the upper support arm supports a vertical string support; the upper support arm near end terminating at the back surface of the vertical mount essentially at the top portion, the upper support arm being supported by
a lower support arm that attaches to the vertical mount, at the back surface, at the bottom portion thereof, the lower support arm extending under the upper support arm and attaching to the under surface of the upper support arm near its distal end, said vertical string support attaching to the distal end of the upper support arm such that the vertical string support extends above the upper support arm.

2. A device as claimed in claim 1 wherein the construction of the device is of a unitary construction.

3. A device as claimed in claim 1 wherein, the device is used in combination with an instrument selected from the group consisting of acoustical guitars, electric guitars, mandolins, violins, banjos, steel guitars, cellos, dulcimers, violas, citterns, ukuleles, rebecs, lutes, ouds, pianos, zithers and their respective basses.

4. A device as claimed in claim 1 wherein, the device is manufactured from material selected from a group consisting of metal, plastic, wood, plastic composite, fiber glass, ceramic, glass, polyvinylchloride, acrylic, graphite.

5. A device as claimed in claim 1 wherein, the vertical string support is adjustable.

6. A device as claimed in claim 1 wherein the device is mounted internally of the stringed instrument.
